(19) United States
(12) Patent Application Publication
(10) Pub. No.: US 2023/0303874 A1
(43) Pub. Date: Sep. 28, 2023

(54) AQUEOUS WHITE INKJET INK AND METHOD FOR PRODUCING PRINTED TEXTILE ITEM

(71) Applicant: RISO KAGAKU CORPORATION, Tokyo (JP)

(72) Inventors: Takumi MATSUDA, Tokyo (JP); Tetsuya SHIRAISHI, Tokyo (JP); Ryo SHINOTSUKA, Tokyo (JP); Akiko HAYASHI, Tokyo (JP); Kokoro KINOE, Tokyo (JP)

(21) Appl. No.: 18/187,105

(22) Filed: Mar. 21, 2023

(30) Foreign Application Priority Data
Mar. 28, 2022 (JP) 2022-051801

(51) Int. Cl. C09D 11/38; C09D 11/322; C09D 11/102; C09D 11/037

(52) U.S. Cl. CPC C09D 11/38; C09D 11/322; C09D 11/102; C09D 11/037; C08K 2003/2237

(57) ABSTRACT

Provided is an aqueous white inkjet ink including: a white pigment; a water-dispersible urethane resin; an amine compound with a molecular weight of 110 to 150; and water, in which an amount of the amine compound with a molecular weight of 110 to 150 relative to a total amount of the ink is 0.2 to 1.3% by mass, and a mass ratio of the amine compound with a molecular weight of 110 to 150 relative to the water-dispersible urethane resin satisfies (a mass of the amine compound with a molecular weight of 110 to 150)/(a mass of the water-dispersible urethane resin)=0.02 to 0.08.

### CROSS REFERENCE TO RELATED APPLICATIONS

This application is based upon and claims the benefit of priority from the prior Japanese Patent Application No. 2022-051801, filed on Mar. 28, 2022, the entire contents of which are incorporated by reference herein.

### BACKGROUND OF THE INVENTION

### Field of the Invention

Embodiments of the present invention relate to an aqueous white inkjet ink and a method for producing a printed textile item.

### Description of the Related Art

An inkjet recording system is a printing system in which a liquid ink having high fluidity is jetted from fine nozzles and adhered to a substrate to thereby perform printing. This system enables printing of high-resolution and high-quality images to be conducted at high speed and with little noise by using a relatively inexpensive device, and has therefore rapidly become widespread in recent years. In terms of inks, aqueous-type inks have become widespread since it is possible to obtain printed matter having high image quality at low cost. Aqueous inks have enhanced drying properties due to containing water, and also have an advantage of excellent environmental friendliness.

For an aqueous inkjet ink, a technique for dispersing a pigment in the ink while reducing the viscosity of the ink has been developed from the viewpoint of the jetting characteristics from an inkjet nozzle. However, a pigment with a large relative density such as a white pigment tends to settle in the ink and is unlikely to redisperse after settling. In an aqueous inkjet ink, by adding a resin component, it is possible to enhance the fixation of an ink image to a substrate and further enhance the coating film strength of the ink image. As this kind of resin component, a water-dispersible urethane resin is excellent, and is especially excellent in terms of the coating film strength of the ink image. However, if the amount of resin added is increased to enhance the coating film strength, the performance of the ink when left in an open state tends to deteriorate further. This deterioration in performance becomes a factor for a deterioration in the jetting characteristics.

Patent JP 2015-124271 A discloses an ink containing a titanium dioxide pigment with a hydrophobic-treated surface, resin particles, and water as an ink in which an inorganic pigment is unlikely to settle and can be redispersed after settling.

Patent JP 2012-149184 A discloses, as an inkjet recording method in which the jetting stability is good and the whiteness of printed matter is high, a method for jetting a white ink composition containing fluorine-based resins, styrene/acrylic-based resins, a white pigment, and water to a swollen-type non-recording medium.

### SUMMARY OF THE INVENTION

One aspect of the present invention provides an aqueous white inkjet ink including: a white pigment; a water-dispersible urethane resin; an amine compound with a molecular weight of 110 to 150; and water, in which an amount of the amine compound with a molecular weight of 110 to 150 relative to a total amount of the ink is 0.2 to 1.3% by mass, and a mass ratio of the amine compound with a molecular weight of 110 to 150 relative to the water-dispersible urethane resin satisfies (mass of the amine compound with a molecular weight of 110 to 150)/(mass of the water-dispersible urethane resin)=0.02 to 0.08.

Another aspect of the present invention provides a method for producing a printed textile item including: applying the aqueous white inkjet ink described above to a fabric by means of an inkjet method; and applying a color ink to the fabric to which the aqueous white inkjet ink has been applied and forming an image.

### DETAILED DESCRIPTION OF THE EMBODIMENTS

The present invention will be described below using embodiments. The invention is not limited by the exemplifications in the following embodiments. The terms and expressions in the following descriptions are not limited by specific examples of the Examples described below.

The techniques disclosed in Patent JP 2015-124271 A and JP 2012-149184 A target the formation of a white image on an OHP sheet and the like, and therefore improvement of the coating film strength has not been sufficiently studied. In addition, in a conventional aqueous inkjet ink, an amine compound is used as a pH adjuster or a water-soluble organic solvent as disclosed in JP 2015-124271 A and JP 2012-149184 A. If an amine compound is used as a pH adjuster, the amount of amine compound is reduced considering the formulation of the ink and the basicity or the like of the amine compound. If an amine compound is used as a water-soluble organic solvent, the amount of amine compound may be adjusted in a range in which the amine compound is made to function as a solvent.

Therefore, in the conventional techniques, it is difficult to obtain good properties of the ink when left in an open state while also increasing the coating film strength of the ink image by combining a water-dispersible urethane resin, which may improve the coating film strength, with a white pigment, and this issue has not been solved. Generally, a small amount of amine compound is blended into the aqueous inkjet ink as a pH adjuster, and the action of the amine compound itself is not fully understood.

Suppose that the dispersibility of the white pigment in the ink decreases, and accordingly the white pigment settles and becomes unlikely to redisperse after settling. In this case, the ink dries and solidifies more easily while open to the atmosphere. In addition, if a water-dispersible urethane resin for increasing the coating film strength is added in the ink, the amount of moisture decreases, and therefore the ink solidifies easily. If the solidification proceeds when the ink is filled in an inkjet nozzle, that is, when the ink is open to the atmosphere, this causes a deterioration in stability within a device.

### <Aqueous White Inkjet Ink>

An aqueous white inkjet ink according to one of the embodiments includes: a white pigment; a water-dispersible urethane resin; an amine compound with a molecular weight of 110 to 150; and water, in which an amount of the amine compound with a molecular weight of 110 to 150 relative to a total amount of the ink is 0.2 to 1.3% by mass, and a mass ratio of the amine compound with a molecular weight of 110 to 150 relative to the water-dispersible urethane resin satisfies (a mass of the amine compound with a molecular weight of 110 to 150)/(a mass of the water-dispersible urethane resin)=0.02 to 0.08.

According to this embodiment, it is possible to provide an aqueous white inkjet ink with excellent properties when left in an open state.

In the following descriptions, the aqueous white inkjet ink is sometimes referred to simply as a white ink or ink.

In an aqueous white ink, as a white pigment, a titanium oxide pigment or the like which has a high relative density is used, and therefore the white pigment tends to settle easily if the white ink is left standing. If the white pigment settles in the white ink, the white pigment and organic components in the ink tend to stick together and become unlikely to redisperse. It is thought that organic components in the ink such as resin particles, a water-soluble organic solvent, and a surfactant interact with the white pigment and cause sticking. If the white pigment settles or sticking occurs, the ink is likely to solidify while it is open to the atmosphere, and this may cause a decline in the properties of the ink when left in an open state.

In an aqueous inkjet ink, water-dispersible urethane resins can enhance the fixation and coating film strength of the ink image on a substrate but tend to stick easily to the white pigment. If the white pigment settles in the ink, the redispersibility of the white pigment tends to decrease due to the sticking of the white pigment and the water-dispersible urethane resins.

An amine compound with a molecular weight of 110 to 150 assists the dispersion stability of the white pigment and the water-dispersible urethane resins, suppresses sticking of the white pigment and the water-dispersible urethane resins even if the white pigment has settled, and can enhance the redispersibility of the white pigment. In addition, the amine compound with a molecular weight of 110 to 150 is less likely to volatilize from the ink. Therefore, the volatilization from a supernatant liquid can be suppressed even if the white pigment has settled. This can enhance the properties of the ink when left in an open state. Meanwhile, the amine compound with a molecular weight of 110 to 150 exhibits basicity. Therefore, if the amine compound is contained in the ink in an amount exceeding a prescribed amount, the dispersion stability of the ink may be reduced.

The amount of the amine compound with a molecular weight of 110 to 150 relative to the total amount of the white ink is preferably 0.2 to 1.3% by mass in the white ink. If the amount of the amine compound with a molecular weight of 110 to 150 relative to the total amount of the ink is at least 0.2% by mass, it is possible to obtain the effect of assisting the dispersion stability of the white pigment and water-dispersible urethane resins. If the amount of the amine compound with a molecular weight of 110 to 150 relative to the total amount of the ink is not more than 1.3% by mass, the effect due to basicity can be reduced and degradation in dispersion stability of the ink can be prevented. If the white ink contains two or more amine compounds with molecular weights of 110 to 150, it is preferable that the total amount of the two or more amine compounds with molecular weights of 110 to 150 satisfies this range.

It is preferable that the mass ratio of the amine compound with a molecular weight of 110 to 150 relative to the water-dispersible urethane resins in the white ink satisfies (the mass of the amine compound with a molecular weight of 110 to 150)/(the mass of the water-dispersible urethane resin)=0.02 to 0.08. If the mass ratio is at least 0.02, it is possible to obtain the effect of assisting the dispersion stability of the white pigment and water-dispersible urethane resins. If the mass ratio is not more than 0.08, the effect due to basicity can be reduced and the degradation in the dispersion stability of the ink can be prevented. In the case that the white ink contains two or more amine compounds with molecular weights of 110 to 150, or two or more water-dispersible urethane resins, the total amount of the two or more amine compounds with molecular weights of 110 to 150 and the total amount of two or more water-dispersible urethane resins preferably satisfy the mass ratio range described above.

That is, it is possible to appropriately control the amount of the amine compound with a molecular weight of 110 to 150 in the ink by specifying the mass ratio of the amine compound with a molecular weight of 110 to 150 relative to the water-dispersible urethane resins together with the amount of the amine compound with a molecular weight of 110 to 150 relative to the total amount of the ink, and accordingly the properties of the ink when left in an open state can be improved.

The amine compound with a molecular weight of 110 to 150 will be described below.

If a molecular weight of the amine compound is at least 110, the volatility of the amine compound can be reduced when left in an environment open to the atmosphere, the amine compound in the ink can be maintained at an appropriate level, and it is possible to obtain the effect of assisting dispersion stability of the white pigment and the water-dispersible urethane resins.

If a molecular weight of the amine compound is not more than 150, the solubility in the aqueous solvent is enhanced and it is possible to obtain the effect of assisting dispersion stability of the white pigment and the water-dispersible urethane resins.

The amine compound is preferably a water-soluble compound. For example, the amine compound is preferably a compound that dissolves in 100 g of water at 25° C. at 0.1 g or more, 1 g or more, or 5 g or more of the amine compound.

The amine compound with a molecular weight of 110 to 150 may be either an aliphatic amine or an aromatic amine, or a combination of these may be used, but the amine compound is preferably an aliphatic amine. The aliphatic amine may be a compound containing an amino group and a saturated or unsaturated linear or branched hydrocarbon group, but preferably alkylamines.

The amine compound with a molecular weight of 110 to 150 may be an amine compound having a hydroxy group. Examples include amino alcohols and the like, and alkanolamines are preferable. In the amine compound having the hydroxy group, from the viewpoint of water solubility, the number of hydroxy groups relative to the molecular weight of the amine compound is preferably at least 0.015, more preferably at least 0.016, and even more preferably at least 0.020.

In the amine compound having the hydroxy group, the number of hydroxy groups relative to the molecular weight of the amine compound is preferably 0.015 to 0.045, more preferably 0.016 to 0.035, and even more preferably 0.020 to 0.030, for example.

In the amine compound having the hydroxy group, the number of hydroxy groups is preferably 1 to 5, 1 to 4, and more preferably 1 to 3.

The amine compound with a molecular weight of 110 to 150 may be a monoamine or a polyvalent amine such as a diamine and triamine, or a combination thereof may be used. From the viewpoint of adjustment of the basicity, the amine compound with a molecular weight of 110 to 150 is preferably monoamine, more preferably alkylmonoamines and monoamino alcohols, even more preferably monoamino alcohols, and still even more preferably alkanol monoamines. From the viewpoint of the adjustment of solubility and basicity, the amine compound with a molecular weight of 110 to 150 preferably contain no heteroatoms except nitrogen atoms and oxygen atoms contained in the hydroxy group.

The amine compound with a molecular weight of 110 to 150 may be any of a primary amine compound, a secondary amine compound, and a tertiary amine compound, and a combination of these may be used.

In the case that the white ink contains a primary amine compound as the amine compound with a molecular weight of 110 to 150, the amount of the primary amine compound relative to the total amount of the ink is preferably 0.2 to 1.3% by mass, and from the viewpoint of suppressing drying of the ink and enhancing the properties of the ink when left in an open state, is more preferably 0.2 to 0.4% by mass, and even more preferably 0.25 to 0.30% by mass. The primary amine compound may contain one or more —NH₂ groups in a molecule, and a primary monoamine compound having one —NH₂ group in a molecule is preferred. One functional group bonded to nitrogen atoms is any monovalent group, such as a saturated or unsaturated linear or branched aliphatic hydrocarbon group. In the one functional group, at least one hydrogen atom may be substituted with a hydroxyl group. Examples of the primary amine compound include 2-amino-2-ethyl-1,3-propanediol, trishydroxymethylaminomethane, and the like.

The mass ratio of a primary amine compound with a molecular weight of 110 to 150 relative to a water-dispersible urethane resin ((the mass of the primary amine compound with a molecular weight of 110 to 150)/(the mass of the water-dispersible urethane resin)) is preferably 0.02 to 0.08, and from the viewpoint of suppressing drying of the ink and enhancing the properties of the ink when left in an open state, is more preferably at least 0.02 and less than 0.03.

In the case that the white ink contains a tertiary amine compound as the amine compound with a molecular weight of 110 to 150, the amount of the tertiary amine compound relative to the total amount of the ink is preferably 0.2 to 1.3% by mass, and from the viewpoint of suppressing drying of the ink and enhancing the properties of the ink when left in an open state, is preferably 1.1 to 1.3% by mass, and even more preferably 1.20 to 1.25% by mass. The tertiary amine compound may contain one or more —NRR′ groups in a molecule, and a tertiary monoamine compound containing one —NRR′ group in a molecule is preferred. R, R′, and one functional group bonded to a nitrogen atom are independently any monovalent group, such as a saturated or unsaturated linear or branched aliphatic hydrocarbon group. In each of the above R, R′, and one functional group bonded to a nitrogen atom, at least one hydrogen atom may be substituted with a hydroxyl group. Examples of the tertiary amine compound include triethanolamine and the like.

The mass ratio of a tertiary amine compound with a molecular weight of 110 to 150 relative to a water-dispersible urethane resin ((the mass of the tertiary amine compound with a molecular weight of 110 to 150)/(the mass of the water-dispersible urethane resin)) is preferably 0.02 to 0.08, and from the viewpoint of suppressing drying of the ink and enhancing the properties of the ink when left in an open state, is more preferably more than 0.06 and not more than 0.08, and even more preferably at least 0.07 and not more than 0.08.

If the white ink contains a secondary amine compound as the amine compound with a molecular weight of 110 to 150, the amount of the secondary amine compound relative to the total amount of the ink is preferably 0.2 to 1.3% by mass. The secondary amine compound may contain one or more —NH— groups in a molecule, and preferably contains one —NH— group in a molecule. Two functional groups bonded to nitrogen atoms are each independently any monovalent group, such as a saturated or unsaturated linear or branched aliphatic hydrocarbon group. In each of the above two functional groups, at least one hydrogen atom may be substituted with a hydroxyl group. Examples of the secondary amine compound include dipropanolamine and the like.

The mass ratio of a secondary amine compound with a molecular weight of 110 to 150 relative to a water-dispersible urethane resin ((the mass of the secondary amine compound with a molecular weight of 110 to 150)/(the mass of the water-dispersible urethane resin)) is preferably 0.02 to 0.08.

In the white ink, the mass ratio of the amine compound with a molecular weight of 110 to 150 relative to the white pigment ((the mass of the amine compound with a molecular weight of 110 to 150)/(the mass of the titanium oxide pigment)) is preferably 0.02 to 0.13 and more preferably 0.02 to 0.125. If the ratio is in these ranges, drying of the ink can be suppressed and the properties of the ink when left in an open state can be further enhanced.

In the case that the white ink contains a primary amine compound as the amine compound with a molecular weight of 110 to 150, the mass ratio of the primary amine compound with a molecular weight of 110 to 150 relative to the white pigment ((the mass of the primary amine compound with a molecular weight of 110 to 150)/(the mass of the titanium oxide pigment)) is preferably 0.02 to 0.13, and from the viewpoint of suppressing drying of the ink to a greater extent, is more preferably 0.03 to 0.04.

In the case that the white ink contains a tertiary amine compound as the amine compound with a molecular weight of 110 to 150, the mass ratio of the tertiary amine compound with a molecular weight of 110 to 150 relative to the white pigment ((the mass of the tertiary amine compound with a molecular weight of 110 to 150)/(the mass of the titanium oxide pigment)) is preferably 0.02 to 0.13, and from the viewpoint of suppressing drying of the ink to a greater extent, is more preferably 0.12 to 0.13.

In the case that the white ink contains a secondary amine compound as the amine compound with a molecular weight of 110 to 150, the mass ratio of a secondary amine compound with a molecular weight of 110 to 150 relative to the white pigment ((the mass of the secondary amine compound with a molecular weight of 110 to 150)/(the mass of the titanium oxide pigment)) is preferably 0.02 to 0.13.

The white ink may contain one amine compound with a molecular weight of 110 to 150 alone or a combination of two or more. The white ink may contain a combination of two or more selected from primary, secondary, and tertiary amine compounds as the amine compound with a molecular weight of 110 to 150, for example.

The water-dispersible urethane resin has a urethane structure and is water-dispersible. Examples include homopolymers or copolymers with urethane bonds in main chains and copolymers with urethane bonds in side chains. By using the water-dispersible urethane resin, the fixation and coating film strength of the ink image can be enhanced by forming a resin coating film on a substrate. In addition, the water-dispersible urethane resin has a large film elongation and is a relatively soft. Therefore, the lowering of the ink fluidity in an open-air environment can be suppressed, and accordingly the performance of the ink when left in an open state can be further enhanced.

The water-dispersible urethane resin is preferably composed of resin particles that can be dispersed in an aqueous solvent, and can be blended into the ink in the form of an oil-in-water resin emulsion, for example. The water-dispersible urethane resin may be a self-emulsifying resin having introduced hydrophilic groups and/or hydrophilic segments that enable stable dispersion in water, or may be a resin having water-dispersibility through use of a separate emulsifier. The water-dispersible urethane resin is preferably a resin that forms a transparent coating film so as not to affect the color of the white pigment.

The water-dispersible urethane resin may be any of an anionic resin, a cationic resin, an amphoteric resin, and a nonionic resin. Considering the stability of the colorant in the aqueous ink, an anionic resin, an amphoteric resin, a nonionic resin, or a combination thereof can be preferably used, and more preferably an anionic resin can be used. As the water-dispersible urethane resin, an anionic urethane resin containing anionic functional groups such as carboxyl groups, sulfo groups, and phosphate groups is preferable.

The water-dispersible urethane resin is preferably as follows: a polyether urethane resin with an ether bond in the main chain in addition to the urethane backbone, a polyester urethane resin with an ester bond in the main chain in addition to the urethane backbone, a polyester-ether urethane resin with an ester bond and an ether bond in the main chain in addition to the urethane backbone, and a polycarbonate urethane resin with a carbonate bond in the main chain in addition to the urethane backbone.

The water-dispersible urethane resin may be either an aliphatic urethane resin or an aromatic urethane resin, but an aliphatic urethane resin is preferable from the viewpoint of transparency of the coating film.

As the aliphatic urethane resin, a reaction product between aliphatic polyisocyanate and polyol can be used. Examples of the polyol include polyether polyol, polyester polyol, polyester ether polyol, and polycarbonate polyol.

As the aliphatic polyisocyanate, an aliphatic polyisocyanate compound containing two or more isocyanate groups in one molecule can be used, and preferably an aliphatic diisocyanate can be used.

The coating film strength of the ink image can be further enhanced and coating film flexibility of the ink image can be obtained by a urethane backbone portion of a water-dispersible urethane resin being an aliphatic urethane backbone, and more preferably, the urethane backbone portion having a chain form derived from an aliphatic diisocyanate.

If a water-dispersible urethane resin synthesized from an aliphatic polyisocyanate is used, the yellowing of the urethane resin itself can be prevented, the resin coating film becomes more transparent, and the whiteness of the white ink can be further improved.

Specific examples of the aliphatic polyisocyanate include ethylene diisocyanate, tetramethylene diisocyanate, pentamethylene diisocyanate, hexamethylene diisocyanate, dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate, 2-isocyanatoethyl-2,6-diisocyanato hexanoate, isophorone diisocyanate, dicyclohexylmethane-4,4′-diisocyanate, and 1,3-bis(isocyanatomethyl)cyclohexan. From thereamong, pentamethylene diisocyanate, hexamethylene diisocyanate, dodecamethylene diisocyanate, or a combination thereof is preferable from the viewpoint of enhancing the coating film flexibility of the ink image.

One of the aliphatic polyisocyanates may be used alone or a combination of two or more may be used.

As the polyether polyol, a polyether compound having two or more hydroxyl groups in one molecule can be used, preferably a chain polyether compound having two or more hydroxyl groups in one molecule is used, and more preferably polyetherdiol is used.

As the polyester polyol, a polyester compound having two or more hydroxyl groups in one molecule can be used, preferably a chain polyester compound having two or more hydroxyl groups in one molecule is used, and more preferably polyester diol is used.

As the polycarbonate polyol, a polycarbonate compound having two or more hydroxyl groups in one molecule can be used, preferably a chain polycarbonate compound having two or more hydroxyl groups in one molecule is used, and more preferably polycarbonate diol is used.

In the water-dispersible urethane resin, if each of the ether bond unit, ester bond unit, and carbonate bond unit is a chain unit, and more preferably if the bond has a chain unit derived from polyether diols, polyester diols, or polycarbonate diols, the coating film strength of the ink image can be further enhanced.

If a water-dispersible urethane resin synthesized from polyether polyol is used, yellowing of the ink image can be further reduced and the water resistance of the ink image can be further improved because the ether part is not affected by hydrolysis. In addition, by using polycarbonate polyol, it is possible to form the ink image with higher coating film strength.

Specific examples of the polyether polyol include polyether polyols such as polyethylene glycol, polypropylene glycol, and polytetramethylene glycol; low-molecular weight polyols such as ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, trimethylene glycol, triethylene glycol, tetraethylene glycol, dipropylene glycol, and tripropylene glycol; and polyether polyol obtained by addition polymerization of an ethylene oxide, propylene oxide, tetramethylene oxide, and the like to the low-molecular weight polyols described above.

Specific examples of the polyester polyols include polyester polyols obtained by polycondensation of polyvalent carboxylic acids such as oxalic acid, malonic acid, succinic acid, glutaric acid, adipic acid, fumaric acid, and maleic acid with the low-molecular weight polyols described above.

Specific examples of the polycarbonate polyols include 1,6-hexanediol polycarbonate diol, 3-methyl-1,5-pentanediol polycarbonate diol, 1,10-decanediol polycarbonate diol, polypropylene carbonate diol, polytetramethylene carbonate diol, polyhexamethylene carbonate diol, and polycyclohexane dimethanol carbonate diol.

One of the polyols described above may be used alone or a combination of two or more may be used.

The water-dispersible urethane resin may be a copolymer of the urethane resin and other resins. Examples include a urethane-modified acrylic resin in which a urethane side chain is introduced into an acrylic main chain. Further, the water-dispersible urethane resin may be a composite resin of the urethane resin and other resins. Examples include urethane acrylic resin particles having a core-shell structure. The water-dispersible urethane resin is preferably present in the ink as a resin particle composed of the single urethane resin from the viewpoint of the fixation and coating film strength of the ink image. It is preferable that the water-dispersible urethane resin is a homopolymer of the urethane resin from the viewpoint of the fixation and coating film strength of the ink image. The water-dispersible urethane resin is preferably present in the ink as a resin particle composed of the homopolymer of the urethane resin.

The water-dispersible urethane resin is preferably present in the ink as a urethane resin particle. The average particle size of the urethane resin particles is preferably not more than 300 nm, more preferably not more than 200 nm, and more preferably not more than 150 nm from the viewpoint of the inkjet jetting characteristics. The average particle size of the urethane resin particles may be within a range from 10 nm to 300 nm, for example. It is also preferable that the average particle size of the urethane resin particles in the urethane resin emulsion to be added into the ink satisfies these ranges.

The average particle size of the resins refers to the volume-based average particle size, and is a numerical value measured by means of a dynamic light scattering method.

Examples of commercially available products of resin emulsions of polyether aliphatic urethane resins include “NeoRezR-650”, “NeoRezR-966”, and “NeoRezR-967” manufactured by DSM Coating Resins, LLC., “SUPERFLEX 130” and “SUPERFLEX E-4800” manufactured by DKS Co., Ltd., “DAOTAN TW6491/33WA” manufactured by Daicel Allnex Ltd., and “Adeka BONTIGHTER HUX-350” and “Adeka BONTIGHTER HUX-550” manufactured by Adeka Corporation (wherein all of the above are product names).

Examples of commercially available products of resin emulsions of polyester aliphatic urethane resins include “DAOTAN TW6490/35WA”, “DAOTAN TW6492/35WA”, and “DAOTAN TW7225/40WA” manufactured by Daicel Allnex Ltd., “NeoRezR-972” and “NeoRezR-9637” manufactured by DSM Coating Resins, LLC., and “SUPERFLEX 210” and “SUPERFLEX 500M” manufactured by DKS Co., Ltd. (wherein all of the above are product names).

Examples of commercially available products of resin emulsions of polycarbonate aliphatic urethane resins include “NeoRezR-986” and “NeoRezR-4000” manufactured by DSM Coating Resins, LLC., “SUPERFLEX 460” and “SUPERFLEX 420” manufactured by DKS Co., Ltd., and “DAOTAN TW7000/40WA” and “DAOTAN TW6450/30WA” manufactured by Daicel Allnex Ltd. (wherein all of the above are product names).

One water-dispersible urethane resin may be used alone or a combination of two or more may be used.

From the viewpoint of the fixation and coating film strength of the ink image, the amount of the water-dispersible urethane resin relative to the total amount of the ink is preferably at least 1% by mass, more preferably at least 5% by mass, and even more preferably at least 10% by mass. From the viewpoint of further enhancing the fixation and coating film strength, the amount of the water-dispersible urethane resin relative to the total amount of the ink is preferably at least 15% by mass and more preferably at least 20% by mass.

From the viewpoints of preventing stickiness of the ink image and the jetting characteristics from the inkjet ink, the amount of the water-dispersible urethane resin relative to the total amount of the ink is preferably not more than 50% by mass, more preferably not more than 40% by mass, and even more preferably not more than 30% by mass. That is, if the amount of water-dispersible urethane resin applied on the substrate increases, the resin fraction of the ink image increases and stickiness may occur. In addition, if the amount of the water-dispersible urethane resin in the ink increases, the ink may become highly viscous and the jetting characteristics from the inkjet nozzle may decrease.

The amount of the water-dispersible urethane resin relative to the total amount of the ink is preferably 1 to 50% by mass, more preferably 10 to 30% by mass, and even more preferably 20 to 24% by mass, for example.

From the viewpoints of enhancing the fixation and coating film strength of the ink image, preventing the stickiness of the ink image, and enhancing the jetting characteristics, the water-dispersible urethane resin, expressed as a mass ratio, relative to 1 part by mass for the white pigment, is preferably 0.1 to 10 parts by mass, more preferably 1 to 5 parts by mass, and even more preferably 1.5 to 3 parts by mass.

The white ink may contain other resins in addition to the water-dispersible urethane resin. Examples of the resins include fixing resins. Although it is possible to obtain the effect of the binder resin by using the water-dispersible urethane resin, other resins may be used to the extent that they do not impair the effect of the present invention.

Other resins may be either water-soluble resins or water-dispersible resins, but water-dispersible resins are preferable from the viewpoint of obtaining the jetting characteristics and storage stability suitable for the inkjet ink. The water-dispersible resin is preferably blended into the white ink in the form of a water-in-oil emulsion and is dispersible in the white ink in the form of a resin particle.

One example of the water-dispersible resin used in combination with the water-dispersible urethane resin includes conjugated diene resins such as styrene-butadiene copolymers, methyl methacrylate-butadiene copolymers, and vinyl chloride-vinyl acetate copolymers; acrylic-based resins such as polymers of acrylic acid esters and methacrylic acid esters, or copolymers thereof with styrene or the like; vinyl-based resins such as ethylene-vinyl acetate copolymers, or functional-group modified resins based on monomers containing functional groups such as carboxyl groups of these various resins; and melamine resins, urea resins, polyester resins, polyolefin resins, silicone resins, polyvinyl butyral resins, and alkyd resins. Resin emulsions containing one of these resins may be used, but hybrid resin emulsions may also be used. Another resin may be used alone or a combination of two or more may be used.

The amount of other resins relative to the total amount of the ink is preferably 1 to 20% by mass. If other resins are contained in the ink, the total amount of water-dispersible urethane resin relative to the total amount of all resins contained in the ink is preferably at least 50% by mass, more preferably at least 80% by mass, and even more preferably at least 90% by mass.

The total amount of the water-dispersible resin and water-soluble resin relative to the total amount of the white ink is preferably 1 to 50% by mass, more preferably 10 to 40% by mass, and even more preferably 20 to 30% by mass. The total amount of the water-dispersible resin and water-soluble resin includes other water-dispersible resins and other water-soluble resins that are optionally included other than the water-dispersible urethane resin.

The white ink may contain a white pigment. The white ink can be used for forming an image showing a white color by containing the white pigment. The white pigment may be either an inorganic pigment or an organic pigment, and a combination of these may be used. Since the white ink of one embodiment is difficult to dry, the decrease in dispersion stability can be prevented even if an inorganic pigment with a large relative density is used.

Examples of the white pigment include a white inorganic pigment such as titanium oxide, zinc oxide, zinc sulfide, antimony oxide, and zirconium oxide. In addition, a white organic pigment such as a hollow resin fine particle or a solid resin fine particle can be used. From thereamong, it is preferable to use a titanium oxide pigment from the viewpoint of concealment properties. From the viewpoint of the concealment properties, the average particle size of the white pigment is preferably at least 50 nm, at least 100 nm, or at least 200 nm, and from the viewpoint of jetting stability, is preferably not more than 500 nm, not more than 400 nm, or not more than 300 nm. From the viewpoint of the concealment properties and jetting stability, the average particle size of a titanium oxide pigment is more preferably 200 to 300 nm. When a titanium oxide pigment is used, it is preferable to use titanium oxide that has been surface treated with alumina, silica, or the like to suppress a photocatalytic action. The amount of surface treatment in the pigment is preferably 5 to 20% by mass.

A self-dispersing pigment may be used as the white pigment. The self-dispersing pigment is a pigment in which a hydrophilic functional group has been introduced into the surface of the pigment by a chemical treatment or physical treatment. The hydrophilic functional group to be introduced into the self-dispersing pigment is preferably ionic, and the pigment particles can be stably dispersed in water by an electrostatic repulsion force by anionically or cationically charging the surface of the pigment. The anionic functional group is preferably a carboxyl group, a sulfo group, a phosphate group, or the like. The cationic functional group is preferably a quaternary ammonium group, a quaternary phosphonium group, or the like.

These hydrophilic functional groups may be bonded directly to the pigment surface or bonded via other atom groups. Examples of other atom groups include, but are not limited to, alkylene groups, phenylene groups, and naphthylene groups. Examples of the pigment surface treatment method include a diazotization treatment, a sulfonation treatment, a hypochlorous acid treatment, a humic acid treatment, and a vacuum plasma treatment.

As the white pigment, a pigment dispersion containing a pigment that has already been dispersed by using a pigment dispersant may also be used. Further, as the white pigment, a microencapsulated pigment obtained by coating the pigment with a resin may be used.

One white pigment may be used alone or a combination of two or more may be used.

From the viewpoint of the concealment properties and the like, the amount of the white pigment relative to the total amount of the white ink is preferably 5 to 30% by mass, more preferably 8 to 20% by mass, and even more preferably 10 to 12% by mass.

A pigment dispersant typified by polymer dispersants, surfactant-type dispersants, and the like may be used to ensure stable dispersion of the white pigment in the white ink.

Examples of commercially available products of the polymer dispersants include the TEGO Dispers series of products such as “TEGO Dispers 740W”, “TEGO Dispers 750W”, “TEGO Dispers 755W”, “TEGO Dispers 757W”, and “TEGO Dispers 760W” manufactured by Evonik Industries AG, the Solsperse series of products such as “Solsperse 20000”, “Solsperse 27000”, “Solsperse 41000”, “Solsperse 41090”, “Solsperse 43000”, “Solsperse 44000”, and “Solsperse 46000” manufactured by The Lubrizol Corporation, the Joncryl series of products such as “Joncryl 57”, “Joncryl 60”, “Joncryl 62”, “Joncryl 63”, “Joncryl 71”, and “Joncryl 501” manufactured by BASF Japan Ltd., as well as “DISPERBYK-102”, “DISPERBYK-185”, “DISPERBYK-190”, “DISPERBYK-193”, and “DISPERBYK-199” manufactured by BYK-Chemie Japan K.K., and “Polyvinylpyrrolidone K-30” and “Polyvinylpyrrolidone K-90” manufactured by DKS Co. Ltd. (wherein all of the above are product names).

Examples of the surfactant-type dispersants include anionic surfactants, including the DEMOL series of products such as “DEMOL P”, “DEMOL EP”, “DEMOL N”, “DEMOL RN”, “DEMOL NL”, “DEMOL RNL”, and “DEMOL T-45” manufactured by Kao Corporation, and nonionic surfactants including the EMULGEN series of products such as “EMULGEN A-60”, “EMULGEN A-90”, “EMULGEN A-500”, “EMULGEN B-40”, “EMULGEN L-40”, and “EMULGEN 420” manufactured by Kao Corporation (wherein all of the above are product names).

One pigment dispersant may be used alone or a combination of two or more may be used.

When the pigment dispersant is used, there are no particular limitations on the amount of the pigment dispersant in the ink, which varies depending on the type of pigment dispersant used, but generally, the amount of the pigment dispersant, expressed as a mass ratio of the active component relative to a value of 1 for the white pigment, is preferably 0.005 to 0.5.

The white ink preferably contains water, and the main solvent may be water. There are no particular limitations on the water, but it is preferably water in which the ionic components are as minimal as possible. In particular, from the viewpoint of storage stability of the white ink, it is preferable that the amount of polyvalent metal ions such as calcium is small. As water, ion-exchanged water, distilled water, ultrapure water, or the like may be used, for example.

From the viewpoint of adjustment of the ink viscosity, the amount contained of water relative to the total amount of white ink is preferably 30 to 90% by mass, more preferably 40 to 85% by mass, and even more preferably 50 to 80% by mass.

The white ink can contain a water-soluble organic solvent.

Organic compounds that are liquids at room temperature (25° C.) and can be dissolved in water can be used as the water-soluble organic solvent, and the use of a water-soluble organic solvent that mixes uniformly with an equal volume of water at 1 atmosphere and 20° C. is preferred.

Examples of organic solvents that may be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as β-thiodiglycol and sulfolane. The boiling point of the water-soluble organic solvent is preferably at least 100° C., and more preferably at least 150° C.

From among the above, glycols, glycerols, or a combination thereof are preferable from the viewpoint of the adjustment of the ink viscosity and a moisture-retaining property. As the glycols, the following are preferable: ethylene glycol, diethylene glycol, triethylene glycol, tetraethylene glycol, propylene glycol, dipropylene glycol, and tripropylene glycol. Glycerol is preferred as the glycerols.

One of these water-soluble organic solvents may be used alone, or a combination of two or more water-soluble organic solvents may be used provided that the solvents form a single phase with water. When two or more water-soluble organic solvents are included, the total amount of the water-soluble organic solvents relative to the total amount of white ink is preferably 10 to 50% by mass, more preferably 15 to 40% by mass, and even more preferably 15 to 30% by mass.

The white ink may further contain surfactants. Examples of surfactants that may be used include anionic surfactants, cationic surfactants, amphoteric surfactants, and nonionic surfactants, but nonionic surfactants are particularly preferred. The surfactant maybe, for example, a low-molecular weight surfactant or a polymer-based surfactant.

The HLB value of the surfactant is preferably 5 to 20 and more preferably 10 to 18.

Examples of the nonionic surfactants include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether ester-based surfactants such as polyoxyethylene sorbitan fatty acid esters; acetylene-based surfactants; silicone-based surfactants; and fluorine-based surfactants. Among these, acetylene-based surfactants such as acetylene glycol-based surfactants can be used favorably.

Examples of the acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group in the center, and may include a structure in which ethylene oxide has been added to acetylene glycol.

Examples of commercially available products of acetylene-based surfactants include the SURFYNOL series of products such as “SURFYNOL 104E”, “SURFYNOL 104H”, “SURFYNOL 420”, “SURFYNOL 440”, “SURFYNOL 465”, and “SURFYNOL 485” manufactured by Evonik Industries AG, and the OLFINE series of products such as “OLFINE E1004”, “OLFINE E1010”, and “OLFINE E1020” manufactured by Nissin Chemical Industry Co., Ltd. (wherein all of the above are product names).

Examples of the silicone-based surfactants include polyether-modified silicone-based surfactants, alkyl-aralkyl-comodified silicone-based surfactants, and acrylic silicone-based surfactants.

Examples of commercially available products of silicone-based surfactants include “SILFACE SAG002” and “SILFACE SAG503A” manufactured by Nissin Chemical Industry Co., Ltd. (wherein both of the above are product names).

Further examples of other nonionic surfactants include polyoxyethylene alkyl ether-based surfactants such as the EMULGEN series of products including “EMULGEN 102KG”, “EMULGEN 103”, “EMULGEN 104P”, “EMULGEN 105”, “EMULGEN 106”, “EMULGEN 108”, “EMULGEN 120”, “EMULGEN 147”, “EMULGEN 150”, “EMULGEN 220”, “EMULGEN 350”, “EMULGEN 404”, “EMULGEN 420”, “EMULGEN 705”, “EMULGEN 707”, “EMULGEN 709”, “EMULGEN 1108”, “EMULGEN 4085”, and “EMULGEN 2025G” manufactured by Kao Corporation (wherein all of the above are product names).

Examples of the anionic surfactants include the EMAL series of products such as “EMAL 0”, “EMAL 10”, “EMAL 2F”, “EMAL 40”, and “EMAL 20C”, the NEOPELEX series of products such as “NEOPELEX GS”, “NEOPELEX G-15”, “NEOPELEX G-25”, and “NEOPELEX G-65”, the PELEX series of products such as “PELEX OT-P”, “PELEX TR”, “PELEX CS”, “PELEX TA”, “PELEX SS-L”, and “PELEX SS-H”, and the DEMOL series of products such as “DEMOL N, DEMOL NL”, “DEMOL RN”, and “DEMOL MS” all manufactured by Kao Corporation (wherein all of the above are product names).

Examples of the cationic surfactants include the ACETAMIN series of products such as “ACETAMIN 24” and “ACETAMIN 86”, the QUARTAMIN series of products such as “QUARTAMIN 24P”, “QUARTAMIN 86P”, “QUARTAMIN 60W”, and “QUARTAMIN 86W”, and the SANISOL series of products such as “SANISOL C” and “SANISOL B-50”, all manufactured by Kao Corporation (wherein all of the above are product names).

Examples of the amphoteric surfactants include the AMPHITOL series of products such as “AMPHITOL 20BS”, “AMPHITOL 24B”, “AMPHITOL 86B”, “AMPHITOL 20YB”, and “AMPHITOL 20N” manufactured by Kao Corporation (wherein all of the above are product names).

A single surfactant may be used alone, or a combination of two or more surfactants may be used.

The amount of surfactant relative to the total amount of white ink is preferably 0.1 to 5% by mass and more preferably 0.2 to 2% by mass.

The white ink may further contain other components. Examples of other components include pH adjusters, preservatives, rust inhibitors, and antifoaming agents.

There are no particular limitations on the method used for producing the white ink, and production may be performed using appropriate conventional methods. The ink may be obtained by using a stirring device such as a three-one motor to disperse all of the components, either in a single batch or in a number of separate batches, and then passing the resulting dispersion through a filtration device such as a membrane filter if desired, for example.

From the viewpoint of the ink storage stability, the pH of the white ink is preferably 7.0 to 10.0 and more preferably 7.5 to 9.0.

Although the viscosity of the white ink can be adjusted appropriately, it is preferable that the viscosity at 23° C. is 1 to 30 mPa s from the viewpoint of jetting characteristics, for example.

The aqueous white inkjet ink according to one of the embodiments can be applied to both a permeable substrate and a non-permeable substrate.

The non-permeable substrate is a substrate into the interior of which a liquid does not permeate, and, specifically, is a substrate with which the majority of the liquid components in the treatment liquid or the ink remains on the surface the substrate.

Examples of the non-permeable substrate include metal substrates such as metal plates of aluminum, iron, copper, titanium, tin, chromium, cadmium, and alloys (for example, stainless steel, steel, and the like); glass substrates such as plate glass of borosilicate glass, quartz glass, and soda lime glass; resin substrates such as resin sheets such as PET films, PP films, OHT sheets, polyester sheets, and polypropylene sheets, as well as acrylic sheets and polyvinyl chloride sheets; and ceramic substrates such as molded products of alumina, zirconia, steatite, and silicon nitride. These substrates may have a plating layer, a metal oxide layer, a resin layer, or the like formed thereon, or may be subjected to a surface treatment using a corona treatment or the like.

Examples of the permeable substrate include printing paper such as plain paper, coated paper, and specialty paper; fabrics such as woven fabrics, knitted fabrics, and non-woven fabrics; porous building materials for humidity control, sound absorption, heat insulation, or the like; wooden materials; concrete; and porous materials. Here, plain paper is paper on which an ink receptive layer, film layer, or the like has not been formed on normal paper. Examples of plain paper include high-quality paper, medium-quality paper, PPC paper, rough paper, and recycled paper. Furthermore, as coated paper, it is possible to preferably use coated inkjet paper such as matte paper, glossy paper, and semi-glossy paper, and what is referred to as coated printing paper. Coated printing paper is printing paper conventionally used for letterpress printing, offset printing, gravure printing, or the like, in which a coating layer is provided on the surface of high-quality or medium-quality paper using a coating containing an inorganic pigment such as clay or calcium carbonate and a binder such as starch. Coated printing paper is classified into finely coated paper, high-quality lightweight coated paper, medium-quality lightweight coated paper, high-quality coated paper, medium-quality coated paper, art paper, cast coated paper, and the like according to the amount of coating and the coating method.

The fibers constituting a fabric include at least one selected from various fibers such as inorganic fibers such as metallic fibers, glass fibers, rock fibers, and slag fibers; recycled fibers such as cellulose-based and protein-based fibers; semi-synthetic fibers such as cellulose-based fibers; synthetic fibers such as polyamide, polyester, polyvinyl chloride, polyvinylidene chloride, polyacrylonitrile, polyvinyl alcohol, polyurethane, polyethylene, polypropylene, polystyrene, and polyfluoroethylene; and natural fibers such as cotton, hemp, silk, and wool.

Since the aqueous white inkjet ink contains the water-dispersible urethane resins, the aqueous white inkjet ink is suitable for printing on a fabric and can be used as an aqueous white inkjet ink for textile printing. The obtained printed textile item has excellent fixation and coating film strength of the ink image, and can also have improved rubbing fastness and washing fastness.

The aqueous white inkjet ink can be applied to a substrate by means of an inkjet method and a white ink image can be formed. The aqueous white inkjet ink may be applied to the substrate as an underlayer. When the aqueous white inkjet ink is used as the underlayer, a non-white color ink can be applied to the substrate on which the underlayer has been formed and an ink image can be formed. Further, the substrate may be pretreated before applying the aqueous white inkjet ink to the substrate. The color ink and the pretreatment liquid will be described below.

### <Color Ink>

A color ink is preferably an aqueous color ink containing a non-white pigment and water, and more preferably an aqueous inkjet ink. Examples of the color ink include a magenta ink, a cyan ink, a yellow ink, and a black ink.

The color ink may contain a pigment, a dye, or a combination thereof as the colorant, but preferably contains a pigment.

Organic pigments such as azo pigments, phthalocyanine pigments, polycyclic pigments, and dye lake pigments, and inorganic pigments such as carbon blacks and metal oxides may be used as the non-white pigment. Examples of the azo pigments include soluble azo lake pigments, insoluble azo pigments and, condensed azo pigments. Examples of the phthalocyanine pigments include metal phthalocyanine pigments and metal-free phthalocyanine pigments. Examples of the polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrrole (DPP)-based pigments. Examples of the carbon blacks include furnace carbon black, lamp black, acetylene black, and channel black. Any one of these pigments may be used alone, or a combination of two or more pigments may be used.

From the viewpoints of the jetting stability and storage stability, the average particle size of the pigment particles in the ink, expressed as the volume-based average value in a particle size distribution measured by means of a dynamic light scattering method, is preferably not more than 300 nm, more preferably not more than 150 nm, and even more preferably not more than 100 nm.

A self-dispersing pigment may be used as the non-white pigment. The details of the self-dispersing pigment are as those described above in relation to the white pigment.

Preferable examples of the self-dispersing pigment include “CAB-O-JET200”, “CAB-O-JET300”, “CAB-O-JET250C”, “CAB-O-JET260M”, “CAB-O-JET270”, and “CAB-O-JET450C” of the CAB-O-JET series manufactured by Cabot Corporation; and “BONJET BLACK CW-1”, “BONJET BLACK CW-2”, “BONJET BLACK CW-3”, and “BONJET BLACK CW-4” manufactured by Orient Chemical Industries Co., Ltd. (all product names).

A microencapsulated pigment in which the pigment has been coated with a resin may also be used as the pigment. Pigment dispersions containing a pigment that has already been dispersed using a pigment dispersant may also be used. Examples of commercially available products of pigment dispersions including the pigment dispersed using a pigment dispersant include the HOSTAJET series of products manufactured by Clariant AG, and the FUJI SP series of products manufactured by Fuji Pigment Co., Ltd.

Examples of dyes that can be used favorably as the dye include water-soluble dyes and dyes that have been made water-soluble by reduction or the like, selected from among basic dyes, acid dyes, direct dyes, soluble vat dyes, acid mordant dyes, mordant dyes, reactive dyes, vat dyes, and sulfide dyes. Further, dispersible dyes such as azo-based dyes, anthraquinone-based dyes, azomethine-based dyes, and nitro-based dyes can also be used favorably. One of these dyes may be used alone, or a combination of a plurality of dyes may be used.

Either a single colorant or a combination of two or more colorants may be used.

From the viewpoint of the print density and ink viscosity, the amount of colorant relative to the total amount of color ink is preferably 0.1 to 20% by mass, more preferably 1 to 15% by mass, and even more preferably 2 to 7% by mass.

In those cases where a pigment is used as the colorant in the color ink, pigment dispersants typified by polymer dispersants, surfactant-type dispersants, and the like may be used to ensure stable dispersion of the pigment in the color ink. Examples of the pigment dispersants include those described above in relation to the white ink, and the pigment dispersant may be selected from among those described above in relation to the white ink.

When the pigment dispersant is used, there are no particular limitations on the amount of the pigment dispersant in the color ink, which varies depending on the type of pigment dispersant used, but generally, the amount of the pigment dispersant, expressed as a mass ratio of the active component relative to a value of 1 for the pigment, is preferably within a range from 0.005 to 0.5.

The color ink preferably contains water. The color ink may contain a water-soluble organic solvent in addition to or instead of water. The details of water and the water-soluble organic solvent are as those described above in relation to the white ink. Examples of the water-soluble organic solvent that may be used include those described above in relation to the white ink, and the water-soluble organic solvent may be selected from among those described above in relation to the white ink.

From the viewpoint of adjustment of the ink viscosity, the amount contained of water relative to the total amount of color ink is preferably 20% by mass to 80% by mass and more preferably 30% by mass to 70% by mass.

The amount of water-soluble organic solvent relative to the total amount of color ink is preferably 5 to 50% by mass and more preferably 10 to 30% by mass.

The color ink may further contain a surfactant. Examples of the surfactant that may be used include those described above in relation to the white ink, and the surfactant may be selected from among those described above in relation to the white ink. Among these, a nonionic surfactant is preferred, and an acetylene-based surfactant such as an acetylene glycol-based surfactant is more preferred.

The active component amount of the surfactant relative to the total amount of color ink is preferably 0.1 to 10% by mass and more preferably 0.2 to 5% by mass.

The color ink may further contain resins such as a water-dispersible resin, a water-soluble resin, and the like. By the color ink containing a fixing resin, it is possible to further enhance the fixation of the ink image to the substrate, the coating film strength of the ink image, and the like, for example. From the viewpoint of obtaining the jetting characteristics and storage stability suitable for the inkjet ink, the color ink preferably contains the water-dispersible resin. The water-dispersible resin is preferably blended into the color ink in the form of a water-in-oil emulsion and is dispersible in the color ink in the form of resin particles. Examples of the water-dispersible resin that may be used include those described above in relation to the white ink, and the water-dispersible resin may be selected from among those described above in relation to the white ink. The water-dispersible resin may be a water-dispersible urethane resin, other water-dispersible resins, or a combination thereof, for example.

The amount of water-dispersible resin relative to the total amount of color ink is preferably 1 to 30% by mass, more preferably 3 to 30% by mass, and even more preferably 5 to 20% by mass.

The color ink may further contain a crosslinking agent. By the color ink containing the crosslinking agent, the coating film strength of the ink image can be further enhanced. If the color ink is used as an aqueous inkjet ink for textile printing, the coating film strength of a printed textile item increases, and this can more suppress cracking of the ink image even after washing, for example. Examples of the crosslinking agent include carbodiimide-based compounds, isocyanate-based compounds, and oxazoline-based compounds.

The amount of crosslinking agent relative to the total amount of color ink is preferably 0.1 to 5% by mass and more preferably 0.2 to 2% by mass.

The color ink may further contain other components. Examples of other components include pH adjusters, preservatives, rust inhibitors, and antifoaming agents.

There are no particular limitations on the method used for producing the color ink, and production may be performed using appropriate conventional methods. The ink may be obtained by using a stirring device such as a three-one motor to disperse all of the components, either in a single batch or in a number of separate batches, and then passing the resulting dispersion through a filtration device such as a membrane filter if desired, for example.

From the viewpoint of the ink storage stability, the pH of the color ink is preferably 7.0 to 10.0 and more preferably 7.5 to 9.0.

Although the viscosity of the color ink can be adjusted appropriately, from the viewpoint of jetting characteristics, it is preferable that the viscosity at 23° C. is 1 to 30 mPa s, for example.

### <Pretreatment Liquid>

In the embodiments, a substrate to which a white ink is to be applied may be pretreated or untreated. By using the pretreated substrate, the image quality of the ink image can be further enhanced and the fixation of the ink image to the substrate can be further enhanced. The pretreated substrate can be obtained by applying a pretreatment liquid to a substrate.

As the pretreatment liquid, a pretreatment liquid containing an aggregating agent and water can be preferably used.

As the aggregating agent, components which have an action of aggregating the colorant within the ink on the substrate may be used. As a result, if the ink is further applied to the substrate to which the pretreatment liquid has been applied, the colorant in the ink aggregates on the substrate, the image density can be further increased, and the blurring of the image can be prevented. Specific examples of the aggregating agent include metal salts, cationic polymers, organic acids, or combinations of these substances.

The total amount of the aggregating agent, expressed as the active component amount, relative to the total amount of the pretreatment liquid is preferably 1 to 30% by mass, more preferably 3 to 30% by mass, and even more preferably 5 to 15% by mass.

As the metal salts, polyvalent metal salts can be preferably used.

Polyvalent metal salts are composed of a divalent or higher polyvalent metal ion and an anion. Examples of the divalent or higher polyvalent metal ion include Ca²⁺, Mg²⁺, Cu²⁺, Ni²⁺, Zn²⁺, and Ba²⁺. Examples of the anion include Cl⁻, NO₃⁻, CH₃COO⁻, I⁻, Br⁻, and ClO₃⁻ Specific examples of the polyvalent metal salts include calcium chloride, calcium nitrate, magnesium nitrate, copper nitrate, calcium acetate, and magnesium acetate.

Cationic water-soluble resins are preferably used as the cationic polymers.

Examples of the cationic water-soluble resins include polyethyleneimine (PEI), polyvinylamine, polyallylamine and salts thereof, polyvinylpyridine, and copolymers of cationic acrylamide. More specifically, for example, resins such as polydiallyldimethylammonium chloride may be used.

Examples of the organic acids include formic acid, acetic acid, propionic acid, butyric acid, isobutyric acid, valeric acid, isovaleric acid, oxalic acid, malonic acid, succinic acid, glutaric acid, maleic acid, fumaric acid, citraconic acid, itaconic acid, tricarballylic acid, glycolic acid, thioglycolic acid, lactic acid, malic acid, tartaric acid, citric acid, isocitric acid, gluconic acid, pyruvic acid, oxalacetic acid, diglycolic acid, benzoic acid, phthalic acid, mandelic acid, and salicylic acid.

The pretreatment liquid preferably contains water. The pretreatment liquid may contain a water-soluble organic solvent in addition to or instead of water. The details of water and the water-soluble organic solvent are as those described above in relation to the white ink. Examples of the water-soluble organic solvent that may be used include those described above in relation to the white ink, and the water-soluble organic solvent may be selected from among those described above in relation to the white ink.

The amount of water relative to the total amount of the pretreatment liquid is preferably 30 to 90% by mass, more preferably 40 to 85% by mass, and even more preferably 50 to 80% by mass.

The amount of water-soluble organic solvent relative to the total amount of the pretreatment liquid is preferably 5 to 50% by mass, more preferably 10 to 40% by mass, and even more preferably 15 to 30% by mass.

The pretreatment liquid may further contain a surfactant. Examples of the surfactant that may be used include those described above in relation to the white ink, and the surfactant may be selected from among those described above in relation to the white ink. Among these, a nonionic surfactant is preferred, and an acetylene-based surfactant such as an acetylene glycol-based surfactant is more preferred.

The active component amount of the surfactant relative to the total amount of the pretreatment liquid is preferably 0.1 to 10% by mass and more preferably 0.2 to 5% by mass.

The pretreatment liquid may further contain other components. Examples of other components include pH adjusters, preservatives, rust inhibitors, and antifoaming agents.

There are no particular limitations on the method used for producing the pretreatment liquid, and production may be performed using appropriate conventional methods. The liquid may be obtained by using a stirring device such as a three-one motor to disperse all of the components, either in a single batch or in a number of separate batches, and then passing the resulting dispersion through a filtration device such as a membrane filter if desired, for example.

### <Method for Producing Printed Textile Item>

A description will be given regarding a method for producing a printed textile item by using an aqueous white inkjet ink according to one of the embodiments.

In one example, printed matter can be produced by applying an aqueous white inkjet ink to a substrate by means of an inkjet method. In another example, printed matter can be produced by applying an aqueous white inkjet ink to a substrate by means of an inkjet method and by applying a color ink to the substrate to which the aqueous white inkjet ink has been applied. The pretreatment liquid may be applied to the substrate before the white ink is applied to the substrate.

One preferred example of a method for producing a printed textile item can include: applying a pretreatment liquid to a fabric; applying a white ink to the substrate to which the pretreatment liquid has been applied by means of an inkjet method; and applying a color ink to the substrate to which the white ink has been applied. In this example, it is preferable that all of the pretreatment liquid, white ink and color ink are applied to the substrate by means of an inkjet method.

An inkjet method is a printing system that can be conducted without substrate contact, in a simple and on-demand manner, and enables free image formation. There are no particular limitations on the inkjet method, and any of a piezo method, electrostatic method, thermal method, and the like may be used. When an inkjet printing device is used, liquid droplets of the pretreatment liquid or ink are preferably jetted from an inkjet head based on a digital signal, with the jetted ink droplets being adhered to the substrate. The inkjet printing device may be either a serial or line head type.

Application of the pretreatment liquid to the substrate will be described below. The area of the substrate to which the pretreatment liquid is applied may be an area having the same shape as the image formed by the white ink, may be a broad area that includes the shape of the image formed by the white ink, or may be the entire surface of the substrate. The application area for the pretreatment liquid, the application area for the white ink, and the application area for the color ink preferably overlap at least partially.

As a method for applying the pretreatment liquid to the substrate, for example, the pretreatment liquid may be applied uniformly to the surface of the substrate by using a brush, roller, bar coater, air knife coater, spray, and the like. Alternatively, the pretreatment liquid may be printed on the image area by means of a printing method such as an inkjet printing method, a gravure printing method, or a flexographic printing method.

The application amount of the pretreatment liquid to the substrate is preferably 5 to 200 g/m2, 10 to 100 g/m2, and more preferably 15 to 80 g/m2.

Next, a description will be given regarding application of a white ink to the substrate to which the pretreatment liquid has been applied by means of an inkjet method.

The area of the substrate to which the white ink is applied may be an area having the same shape as the image formed by the color ink, may be a broad area that includes the shape of the image formed by the color ink, or may be the entire surface of the substrate. The application area for the white ink and the application area for the pretreatment liquid preferably overlap at least partially.

The amount of the white ink applied to the substrate is not particularly limited, but is preferably 80 to 400 g/m2 and more preferably 120 to 250 g/m2, for example.

Next, a description will be given regarding application of a color ink to the substrate to which the white ink has been applied.

It is preferable that the application area for the color ink and the application area for the white ink overlap at least partially.

As the method for applying the color ink to the substrate, any of the following may be used: an inkjet printing method, an offset printing method, a screen printing method, a gravure printing method, a flexographic printing method, and the like.

The amount of the color ink applied to the substrate is not particularly limited, but is preferably 1 to 100 g/m2 and more preferably 5 to 50 g/m2, for example.

One color ink may be applied or two or more color inks may be applied.

The white ink may be applied to the substrate by means of a wet-on-wet method after the pretreatment liquid is applied to the substrate, or the white ink may be applied to the substrate after the substrate is dried. In the wet-on-wet method, the white ink is preferably applied in a state where the moisture has not been completely removed from the substrate to which the pretreatment liquid has been applied. It is preferable that the white ink may be applied while the substrate to which the pretreatment liquid has been applied is maintained in a wet state. For example, following application of the pretreatment liquid to the substrate, the white ink is preferably applied to the substrate without first conducting a drying step such as heated drying. Similarly, after applying the white ink to the substrate, the color ink may be applied to the substrate by means of the wet-on-wet method, or after drying the substrate, the color ink may be applied to the substrate.

A step of heat-treating the substrate after the application of the white or color ink can be further provided. This makes the ink image more fixed.

The heat-treatment temperature can be appropriately selected according to the material of the substrate and the like. The heat-treatment temperature is preferably at least 100° C. and more preferably at least 150° C., for example. From the viewpoint of reducing any damage to the substrate, the heat-treatment temperature is preferably not more than 200° C.

There are no particular limitations on the heating device, and for example, a heat press, roll heater, hot air device, infrared lamp heater, or the like may be used.

The heat treatment time may be selected appropriately in accordance with the heating method and the like, and is preferably 1 second to 10 minutes. The heat treatment time may be 5 seconds to 5 minutes, for example.

The application of the pretreatment liquid, the application of the white ink, and the application of the color ink may be performed by using separate printing devices or by using a single printing device. For example, two printing devices may be used, the application of the pretreatment liquid may be performed by using one of the printing devices, and the application of the white ink and the application of the color ink may be performed by using the other of the printing devices.

An overcoat layer may be formed on the substrate after the application of the white ink or on the substrate after the application of the white and color inks. The overcoat layer can be formed by applying a post-treatment liquid to the substrate after the application of the ink. As the post-treatment liquid, for example, a post-treatment liquid containing a resin capable of forming a coating film and an aqueous or oil-based medium can be used. Following the application of the white or color ink, heating the substrate may be provided, followed by the application of the post-treatment liquid. The post-treatment liquid may also be applied by means of the wet-on-wet method following the application of the color ink. Further, heating of the substrate may also be provided after the application of the post-treatment liquid.

A printed textile item can be produced by using a fabric as a substrate in the method for producing the printed matter described above. Specifically, one example of a method for producing a printed textile item can include applying an aqueous white inkjet ink to a fabric by means of an inkjet method and applying a color ink to the fabric substrate to which the aqueous white inkjet ink has been applied and forming an image. As the color ink, a monochromatic color ink such as a magenta ink, a cyan ink, a yellow ink, or a black ink may be used, or a multicolor ink obtained by combining these may be used. Furthermore, the method for producing the printed textile item can include applying the pretreatment liquid to the fabric before applying the aqueous white inkjet ink to the fabric by means of an inkjet method. Both of the color ink and pretreatment liquid can be independently applied to the substrate by means of the inkjet method, but may be applied by means of other methods.

Details of the aqueous white inkjet ink, color ink, and pretreatment liquid are as those described above.

### <Ink Set>

According to one of the embodiments, it is possible to provide an ink set having an aqueous white inkjet ink and a color ink. According to another embodiment, it is possible to provide an ink set having a pretreatment liquid, an aqueous white inkjet ink, and a color ink. These ink sets may further contain a post-treatment liquid. These ink sets can be provided as an ink set for textile printing when a fabric is used as a substrate. The aqueous white inkjet ink contains a water-dispersible urethane resin, and therefore it is possible to enhance the fixation and coating film strength of the ink image. In addition, since the amount of the amine compound in the aqueous white inkjet ink is appropriately controlled, it is possible to suppress the settling and sticking of the white pigment and obtain excellent properties of the ink when left in an open state. Details of the aqueous white inkjet ink, color ink, and pretreatment liquid are as those described above.

### EXAMPLES

The present invention will be described below in further detail using a series of examples, but the present invention is in no way limited by the following examples. In the following description, “%” represents “% by mass” unless specifically stated otherwise.

“Production of white pigment dispersion” First, 400 g of titanium oxide “R-21N” (manufactured by Sakai Chemical Industry Co., Ltd.) as a white pigment, and 20 g (active component: 5 g) of “DEMOL EP” (manufactured by Kao Corporation) as a pigment dispersant were mixed with 580 g of ion-exchanged water, and a beads mill (“DYNO-MILL KDL model A”, manufactured by Shinmaru Enterprises Corporation) containing 0.5 mmØ zirconia beads at a fill ratio of 80% by volume was used to disperse the mixture under conditions including a residence time of 5 minutes, thus obtaining a white pigment dispersion (pigment fraction: 40% by mass).

“Production of White Ink”

Tables 1 to 3 show the ink formulations. The raw materials were mixed according to the formulations shown in the tables and the obtained mixture was stirred at 100 rpm for 20 minutes using a mix rotor to obtain a white ink. The amounts shown in the tables are the active component amounts such as solid fraction amounts or solid fractions. In Tables 1 to 3, Ex. 1 to Ex. 12 respectively represent Example 1 to Example 12, and Comp. Ex. 1 to Comp. Ex. 8 respectively represent Comparative Example 1 to Comparative Example 8.

“Evaluation of Ink Fluidity after being Left in an Open State”

To evaluate the performance of the ink when left in an open state, the fluidity of the ink after being left in an open state was evaluated. An amount of 2 g of a white ink was added to a Petri dish with a diameter of 35.4 mm. Thereafter, the Petri dish was left in a thermostatic chamber at 40° C. for one hour, after which the fluidity of the ink in the Petri dish was checked visually. The following criteria were used to evaluate the fluidity of the ink after being left in an open state.

A: There is almost no change in the fluidity of the ink after being left compared with the ink before being left.

B: The fluidity of the ink after being left is slightly inferior to that of the ink before being left.

C: The ink solidified after being left.

The components used were as follows.
Urethane resin emulsion, “DAOTAN TW6450/30WA” (product name): manufactured by Daicel Allnex Ltd., resin faction: 30% by mass
Urethane resin emulsion, “NeoRezR-967” (product name): manufactured by DSM Coating Resins, LLC., resin fraction: 40% by mass
Acrylic resin emulsion “NeoCryl XK-12” (product name): manufactured by DSM Coating Resins, LLC., resin fraction: 45% by mass
Surfactant “OLFINE E1010” (product name): manufactured by Nissin Chemical Industry Co., Ltd., acetylene glycol-based surfactant, active component amount: 100% by mass

Details of the amine compounds used were as follows.

2-amino-2-ethyl-1,3-propanediol: a primary amine, a molecular weight was 119.16, the number of hydroxyl groups was 2, and the number of hydroxyl groups relative to the molecular weight was 0.017.

Triethanolamine: a tertiary amine, a molecular weight was 149.188, the number of hydroxyl groups was 3, and the number of hydroxyl groups relative to the molecular weight was 0.020.

Diisopropanolamine: a secondary amine, a molecular weight was 133.191, the number of hydroxyl groups was 2, and the number of hydroxyl groups relative to the molecular weight was 0.015.

Diethylamine: a secondary amine, a molecular weight was 73.14, and the number of hydroxy groups was 0.

Tridodecylamine: a tertiary amine, a molecular weight was 522.00, and the number of hydroxy groups was 0.

TABLE 1
Ink formulation and evaluation result

| Units: % by mass | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| White pigment dispersion | | Pigment | 10.00 | 10.00 | 10.00 | 10.00 | 10.00 | 10.00 | 10.00 | 10.00 |
| | | fraction | | | | | | | | |
| Urethane resin emulsion | | Resin | 16.00 | 16.00 | 16.00 | 16.00 | 16.00 | 16.00 | 16.00 | 16.00 |
| “DAOTAN TW6450/30WA” | | fraction | | | | | | | | |
| Urethane resin emulsion | | Resin | — | — | — | — | — | — | — | — |
| “NeoRezR-967” | | fraction | | | | | | | | |
| Acrylic resin emulsion | | Resin | — | — | — | — | — | — | — | — |
| “NeoCryl XK-12” | | fraction | | | | | | | | |
| Solvent | Glycerol | — | 10.00 | 10.00 | 10.00 | 10.00 | 10.00 | 10.00 | 10.00 | 10.00 |
| | 1,3-propanediol | — | 5.00 | 5.00 | 5.00 | 5.00 | 5.00 | 5.00 | 5.00 | 5.00 |
| Surfactant | OLFINE E1010 | Active | 0.70 | 0.70 | 0.70 | 0.70 | 0.70 | 0.70 | 0.70 | 0.70 |
| | | component | | | | | | | | |
| Amine | 2-amino-2-ethyl- | Molecular | 0.25 | 0.50 | 1.00 | 1.25 | — | — | — | — |
| compound | 1,3-propanediol | weight | | | | | | | | |
| | | 119.16 | | | | | | | | |
| | Triethanolamine | Molecular | — | — | — | — | 0.25 | 0.50 | 1.00 | 1.25 |
| | | weight | | | | | | | | |
| | | 149.188 | | | | | | | | |
| | Diisopropanolamine | Molecular | — | — | — | — | — | — | — | — |
| | | weight | | | | | | | | |
| | | 133.191 | | | | | | | | |
| | Diethylamine | Molecular | — | — | — | — | — | — | — | — |
| | | weight | | | | | | | | |
| | | 73.14 | | | | | | | | |
| | Tridodecylamine | Molecular | — | — | — | — | — | — | — | — |
| | | weight | | | | | | | | |
| | | 522.00 | | | | | | | | |

| | | | | | | | | |
|---|---|---|---|---|---|---|---|---|
| Water | Remainder | Remainder | Remainder | Remainder | Remainder | Remainder | Remainder | Remainder |
| Total (% by mass) | 100.00 | 100.00 | 100.00 | 100.00 | 100.00 | 100.00 | 100.00 | 100.00 |

| | | | | | | | | |
|---|---|---|---|---|---|---|---|---|
| Amine compound/white pigment | 0.03 | 0.05 | 0.10 | 0.13 | 0.03 | 0.05 | 0.10 | 0.13 |
| (mass ratio) | | | | | | | | |
| Amine compound/water-dispersible resin | 0.02 | 0.03 | 0.06 | 0.08 | 0.02 | 0.03 | 0.06 | 0.08 |
| (mass ratio) | | | | | | | | |
| Ink fluidity | A | B | B | B | B | B | B | A |

TABLE 2
Ink formulation and evaluation result

| Units: % by mass | | | Ex. 9 | Ex. 10 | Ex. 11 | Ex. 12 |
|---|---|---|---|---|---|---|
| White pigment dispersion | | Pigment | 10.00 | 10.00 | 10.00 | 10.00 |
| | | fraction | | | | |
| Urethane resin emulsion | | Resin | 16.00 | 16.00 | 20.00 | — |
| “DAOTAN TW6450/30WA” | | fraction | | | | |
| Urethane resin emulsion | | Resin | — | — | — | 16.00 |
| “NeoRezR-967” | | fraction | | | | |
| Acrylic resin emulsion | | Resin | — | — | — | — |
| “NeoCryl XK-12” | | fraction | | | | |
| Solvent | Glycerol | — | 10.00 | 10.00 | 10.00 | 10.00 |
| | 1,3-propanediol | — | 5.00 | 5.00 | 5.00 | 5.00 |
| Surfactant | OLFINE E1010 | Active | 0.70 | 0.70 | 0.70 | 0.70 |
| | | component | | | | |
| Amine | 2-amino-2-ethyl- | Molecular | — | — | — | 0.25 |
| compound | 1,3-propanediol | weight | | | | |
| | | 119.16 | | | | |
| | Triethanolamine | Molecular | — | — | 1.25 | — |
| | | weight | | | | |
| | | 149.188 | | | | |
| | Diisopropanolamine | Molecular | 0.50 | 1.00 | — | — |
| | | weight | | | | |
| | | 133.191 | | | | |
| | Diethylamine | Molecular | — | — | — | — |
| | | weight | | | | |
| | | 73.14 | | | | |
| | Tridodecylamine | Molecular | — | — | — | — |
| | | weight | | | | |
| | | 522.00 | | | | |

| | | | | |
|---|---|---|---|---|
| Water | Remainder | Remainder | Remainder | Remainder |
| Total (% by mass) | 100.00 | 100.00 | 100.00 | 100.00 |

| | | | | |
|---|---|---|---|---|
| Amine compound/white pigment | 0.05 | 0.10 | 0.13 | 0.03 |
| (mass ratio) | | | | |
| Amine compound/water-dispersible resin | 0.03 | 0.06 | 0.06 | 0.02 |
| (mass ratio) | | | | |
| Ink fluidity | B | B | A | A |

TABLE 3
Ink formulation and evaluation result

| | | | Comp. | Comp. | Comp. | Comp. | Comp. | Comp. | Comp. | Comp. |
|---|---|---|---|---|---|---|---|---|---|---|
| Units: % by mass | | | Ex. 1 | Ex. 2 | Ex. 3 | Ex. 4 | Ex. 5 | Ex. 6 | Ex. 7 | Ex. 8 |
| White pigment dispersion | | Pigment | 10.00 | 10.00 | 10.00 | 10.00 | 10.00 | 10.00 | 10.00 | 10.00 |
| | | fraction | | | | | | | | |
| Urethane resin emulsion | | Resin | 16.00 | 20.00 | 11.00 | 11.00 | 20.00 | 16.00 | 16.00 | — |
| “DAOTAN TW6450/30WA” | | fraction | | | | | | | | |
| Urethane resin emulsion | | Resin | — | — | — | — | — | — | — | — |
| “NeoRezR-967” | | fraction | | | | | | | | |
| Acrylic resin emulsion | | Resin | — | — | — | — | — | — | — | 16.00 |
| “NeoCryl XK-12” | | fraction | | | | | | | | |
| Solvent | Glycerol | — | 10.00 | 10.00 | 10.00 | 10.00 | 10.00 | 10.00 | 10.00 | 10.00 |
| | 1,3-propanediol | — | 5.00 | 5.00 | 5.00 | 5.00 | 5.00 | 5.00 | 5.00 | 5.00 |
| Surfactant | OLFINE E1010 | Active | 0.70 | 0.70 | 0.70 | 0.70 | 0.70 | 0.70 | 0.70 | 0.70 |
| | | component | | | | | | | | |
| Amine | 2-amino-2-ethyl- | Molecular | — | — | — | — | — | — | — | — |
| compound | 1,3-propanediol | weight | | | | | | | | |
| | | 119.16 | | | | | | | | |
| | Triethanolamine | Molecular | — | 1.50 | 0.10 | 1.00 | 0.25 | — | — | 0.25 |
| | | weight | | | | | | | | |
| | | 149.188 | | | | | | | | |
| | Diisopropanolamine | Molecular | — | — | — | — | — | — | — | — |
| | | weight | | | | | | | | |
| | | 133.191 | | | | | | | | |
| | Diethylamine | Molecular | — | — | — | — | — | 1.00 | — | — |
| | | weight | | | | | | | | |
| | | 73.14 | | | | | | | | |
| | Tridodecylamine | Molecular | — | — | — | — | — | — | 0.50 | — |
| | | weight | | | | | | | | |
| | | 522.00 | | | | | | | | |

| | | | | | | | | |
|---|---|---|---|---|---|---|---|---|
| Water | Remainder | Remainder | Remainder | Remainder | Remainder | Remainder | Remainder | Remainder |
| Total (% by mass) | 100.00 | 100.00 | 100.00 | 100.00 | 100.00 | 100.00 | 100.00 | 100.00 |

| | | | | | | | | |
|---|---|---|---|---|---|---|---|---|
| Amine compound/white pigment | — | 0.15 | 0.01 | 0.10 | 0.03 | 0.10 | 0.05 | 0.03 |
| (mass ratio) | | | | | | | | |
| Amine compound/water-dispersible resin | — | 0.08 | 0.01 | 0.09 | 0.01 | 0.06 | 0.03 | 0.02 |
| (mass ratio) | | | | | | | | |
| Ink fluidity | C | C | C | C | C | C | C | C |

As shown in the tables, the white inks of each example had excellent ink fluidity. This reveals that the ink had excellent properties when left in an open state, when the inkjet head is filled with the ink.

The amine compound was not used in Comparative Example 1, the amount of the amine compound and the mass ratio of the amine compound/the water-dispersible resin were not suitable in Comparative Examples 2 to 5, the molecular weight of the amine compound was not suitable in Comparative Examples 6 and 7, and the type of the water-dispersible resin was not suitable in Comparative Example 8. In these comparative examples, the ink fluidity decreased.

“Printing on Fabric Substrate”

A printed textile item was produced by printing the white inks obtained through Examples 1 to 12 on fabric substrates. As the fabric substrates, black 100% cotton T-shirts “Printstar 085-cvt” (manufactured by Toms Co., Ltd.) were used. Pretreatment liquids for pretreating the fabric substrates were produced before the white inks were printed on the fabric substrates. Specifically, the raw materials were mixed according to the following formulations, and any coarse particles were removed with a membrane filter having a pore size of 3 μm, thus producing the pretreatment liquid.
Aggregating agent: calcium chloride 20.0% by mass
Water-soluble organic solvent: 1,4-butanediol 25.0% by mass
Surfactant: “OLFINE E1010” (product name) 0.5% by mass
Water: ion-exchanged water 54.5% by mass
Total 100.0% by mass

First, two inkjet printers (textile printers “MMP-8130” manufactured by Mastermind Inc.) were prepared, the pretreatment liquid was introduced to the first printer (hereinafter sometimes referred to as “printer 1”), and the white ink was introduced to the second printer (hereinafter sometimes referred to as “printer 2”). A printed textile item was produced by using the white inks of Examples 1 to 12 by means of the following steps 1 to 3.

Step 1: In step 1, the pretreatment liquid was applied to the entire area of 100 mm×200 mm of the substrate such that the applied amount of the pretreatment liquid was 50 g/m2 by using the printer 1 to which the pretreatment liquid had been introduced.

Step 2: In step 2, the white ink was applied to the substrate to which the pretreatment liquid had been applied by using the printer 2 by means of a wet-on-wet method. In this step 2, a white solid image of 100 mm×200 mm was printed on the substrate area of 100 mm×200 mm to which the pretreatment liquid had been applied such that the amount of white ink applied was 200 g/m2.

Step 3: In step 3, the printed T-shirts were heat-treated at 160° C. for 120 seconds by using a Hotronix Fusion Heat Press (manufactured by Stahls Hotronix Inc.)

Inkjet printing using the white inks of each example was performed without any problems, and the white image was formed well on the obtained printed textile item.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An aqueous white inkjet ink comprising:
a white pigment;
a water-dispersible urethane resin;
an amine compound with a molecular weight of 110 to 150; and
water, wherein
an amount of the amine compound with a molecular weight of 110 to 150 relative to a total amount of the ink is 0.2 to 1.3% by mass, and
a mass ratio of the amine compound with a molecular weight of 110 to 150 relative to the water-dispersible urethane resin satisfies (a mass of the amine compound with a molecular weight of 110 to 150)/(a mass of the water-dispersible urethane resin)=0.02 to 0.08.

2. The aqueous white inkjet ink according to claim 1, wherein
the amine compound with a molecular weight of 110 to 150 contains a primary amine compound, and an amount of the primary amine compound relative to the total amount of the ink is 0.2 to 0.4% by mass.

3. The aqueous white inkjet ink according to claim 1, wherein
the amine compound with a molecular weight of 110 to 150 contains a tertiary amine compound, and an amount of the tertiary amine compound relative to the total amount of the ink is 1.1 to 1.3% by mass.

4. The aqueous white inkjet ink according to claim 1, wherein
the amine compound with a molecular weight of 110 to 150 contains an amine compound having a hydroxy group in which a number of hydroxy groups relative to the molecular weight of the amine compound is at least 0.016.

5. The aqueous white inkjet ink according to claim 2, wherein
the amine compound with a molecular weight of 110 to 150 contains an amine compound having a hydroxy group in which a number of hydroxy groups relative to the molecular weight of the amine compound is at least 0.016.

6. The aqueous white inkjet ink according to claim 3, wherein
the amine compound with a molecular weight of 110 to 150 contains an amine compound having a hydroxy group in which a number of hydroxy groups relative to the molecular weight of the amine compound is at least 0.016.

7. A method for producing a printed textile item, the method comprising:
applying the aqueous white inkjet ink according to claim 1 to a fabric by means of an inkjet method; and
applying a color ink to the fabric to which the aqueous white inkjet ink has been applied and forming an image.

8. The method for producing a printed textile item according to claim 7, wherein
the amine compound with a molecular weight of 110 to 150 contains a primary amine compound, and an amount of the primary amine compound relative to the total amount of the ink is 0.2 to 0.4% by mass.

9. The method for producing a printed textile item according to claim 7, wherein
the amine compound with a molecular weight of 110 to 150 contains a tertiary amine compound, and an amount of the tertiary amine compound relative to the total amount of the ink is 1.1 to 1.3% by mass.

10. The method for producing a printed textile item according to claim 7, wherein
the amine compound with a molecular weight of 110 to 150 contains an amine compound having a hydroxy group in which a number of hydroxy groups relative to the molecular weight of the amine compound is at least 0.016.

11. The method for producing a printed textile item according to claim 8, wherein
the amine compound with a molecular weight of 110 to 150 contains an amine compound having a hydroxy group in which a number of hydroxy groups relative to the molecular weight of the amine compound is at least 0.016.

12. The method for producing a printed textile item according to claim 9, wherein
the amine compound with a molecular weight of 110 to 150 contains an amine compound having a hydroxy group in which a number of hydroxy groups relative to the molecular weight of the amine compound is at least 0.016.
